(19) United States
(12) Patent Application Publication
(10) Pub. No.: US 2016/0339420 A1
(43) Pub. Date: Nov. 24, 2016

(54) MODULAR COOLING STORAGE SYSTEM

(71) Applicant: NSC MED GMBH, Seevetal (DE)

(72) Inventors: Dennis Machling, Seevetal (DE); Robert Koppen, Seevetal (DE)

(21) Appl. No.: 15/029,348

(22) PCT Filed: Oct. 14, 2014
(86) PCT No.: PCT/EP2014/071980

§ 371 Date: Jul. 26, 2016

(30) Foreign Application Priority Data
Oct. 15, 2013 (DE) 20 2013 104 657.4

(51) Int. Cl. B01L 1/02; F25D 25/02; F25D 29/00; F25D 23/06; F25D 11/00; A01N 1/02; F25D 23/02

(52) U.S. Cl. CPC B01L 1/025; A01N 1/0252; F25D 25/02; F25D 23/025; F25D 23/065; F25D 23/062; F25D 11/00; F25D 23/028; F25D 29/003; B01L 2200/028; B01L 2300/0609; B01L 2300/1894; B01L 2200/147; B01L 2200/143; F25D 2400/16; F25D 2400/361; F25D 2201/14

(57) ABSTRACT

A modular cooling storage system is disclosed, which has one or more storage containers, wherein each have cold-insulating walls including at least one side wall, a bottom, and a cover; wherein the cold-insulating walls each have two opposite lateral surfaces, which are connected to each other in a thickness direction by edge surfaces; and each storage container has at least one closable access opening. The lateral surfaces and/or edge surfaces of at least one of the walls of each storage container have integrated coupling elements, wherein the coupling elements are designed in such a way that the coupling elements engage with the coupling elements of a directly adjacent wall of a further storage container, wherein storage containers engaged with each other along a section of the walls of the storage containers have a common wall in the section.

### TECHNICAL FIELD

The invention relates to a cooling storage system for storing biological, medical and/or other samples, materials and/or substances to be preserved.

Biological and/or medical material requires low temperatures down to −86° C. or lower, in particular for long storage times. Biological material which is stored can comprise, e.g. cells that should be viable again after defrosting, proteins, genetic material or stored blood.

### PRIOR ART

Refrigerators are described in the prior art, which are suitable in principle, but are disadvantageous in certain aspects. For instance, in particular to store large volumes of biological and/or medical material, a large storage space is the required that necessarily has to have a large access door as well. Therefore, each time when an item to be cooled is removed or deposited, significant heat exchange with the surroundings occurs. Thus, defined storage conditions for the sensitive stored items cannot be maintained upon frequent depositing/removal operations, and damage to the stored items therefore cannot be excluded.

As an alternative to a cooling storage system with a large volume, the use of several, separate refrigerators is expedient. However, when using several refrigerators, not only the installation area increases, but an increased number of cold-insulating components is also necessary, and the control as well as the storage management of the individual refrigerators is complicated. A separate use of several refrigerators is therefore disadvantageous regarding the installation area, the material effort, the plurality of parts and the logistics of a cooling storage system.

### DESCRIPTION OF THE INVENTION

Accordingly, it is an object of the present invention to provide a cooling storage system with a large cooling volume, which guarantees a low heat influx when items are put into or taken out of storage and, on the other hand, ensures a small installation area upon a low material effort.

This object is solved by the modular cooling storage system according to claim 1. Preferred embodiments are apparent from the other claims.

According to the invention, the modular cooling storage system comprises one or more storage containers, which each have cold-insulating walls. The storage containers comprise at least one side wall, a bottom and a cover. The cold-insulating walls each have two opposite lateral surfaces, which are connected to each other in a thickness direction by edge surfaces. Each storage container is further configured such that it has at least one closable access opening. The lateral surfaces and/or edge surfaces of at least one wall of each storage container have integrated coupling elements. The coupling elements are designed in such a way that they can engage with the coupling elements of a directly adjacent wall of a further storage container. Moreover, the storage containers engaged with each other along a section of the walls of the storage containers have a common wall in this section.

For instance, clamp latches can be used as coupling elements. Of two coupling elements engaged with each other, the one is configured as a clamping element and the other as a retaining element, where a tension hook of the clamping element engages with the retaining element. This guarantees high coupling security and, at the same time, enables multiple actuation and makes the system structure flexible and modular.

The modular system structure according to the invention has the advantage that when extending one cold-insulating storage container by further storage containers the space necessary for the installation area is reduced since the systems are connected with each other.

To be able to use these connection possibilities optimally in each spatial direction, it is advantageous that each storage container is substantially cuboid in geometry. Thus, the storage containers, which are arranged next to each other to be completely flush (i.e. exactly or completely covering each other) and are engaged with each other, have common side walls, whereby the necessary material and the number of cold-insulating walls of the entire modular cooling storage system can be further reduced. Furthermore, the necessary mounting time and the interface area between the cooling space and the surroundings, which is available for the undesired heat transfer, are thus reduced.

The cuboid shape of the storage containers can be specified to the effect that one side wall of each of the storage containers, which is opposite to the respective access opening, is formed as the rear wall of the respective storage container and has a height h and a width b. Accordingly, one side wall of each of the storage containers, in which the access opening is provided, has the height h and the width b.

The other side walls have a height h and a length 1, while the covers and the bottoms thus each have the length 1 and the width b. Furthermore, the cold-insulating walls have four edge surfaces each with the thickness d. Furthermore, it is advantageous that the covers and/or bottoms of directly adjacent storage containers engaging with each other extend uniformly over all directly adjacent storage containers. Thus, both the material effort as well as the mounting time can be further reduced.

Irrespective of the cuboid geometry, it is further advantageous that storage containers, which are arranged on top of each other to be completely flush (i.e. exactly or completely covering each other) and are engaged with each other, have a common wall that serves as the cover of the lower storage containers and as the bottom of the upper storage containers. This in turn reduces the material effort, the mounting time and the temperature interface area between the cooling space and the surroundings.

If the storage containers are cuboid, according to a preferred embodiment, the edge surfaces of the bottoms and the covers have at least two and a maximum of 10 coupling elements each. These are arranged in the thickness direction substantially in the middle of the edge surfaces, with one coupling element being arranged on each edge surface in spatial vicinity of an edge which separates two edge surfaces from each other. In this regard, the expression “spatial vicinity” here and below relates to a distance in the range of the thickness d of the edge surfaces. The lateral surfaces of the bottom and of the cover have 4*n coupling elements each, with n being a minimum of one and a maximum of 10 and preferably 2. In this regard, n coupling elements each are arranged along a lateral edge, which separates a lateral surface from an edge surface, at a distance of substantially d/2 from the lateral edge.

Preferably, the edge surfaces of the side walls have n coupling elements along the length 1, which are arranged in such a way that they can engage with the coupling elements on the lateral surfaces along the corresponding lateral edge of the covers and the bottoms. The edge surfaces of the rear walls also have n coupling elements along the width b, which are arranged in such a way that they can engage with the coupling elements on the lateral surfaces along the corresponding lateral edges of the covers and the bottoms.

The edge surfaces of the rear walls have m coupling elements each along the height h, with m being a minimum of 2 and a maximum of 10 and preferably 3. In this regard, one coupling element each is arranged in spatial vicinity of one of the two edges which separate the edge surfaces along the height h from the adjacent edge surfaces along the width b.

Accordingly, the lateral surfaces of the side walls also have n coupling elements each along the height h. These are arranged at a distance of substantially d/2 from the lateral edge which separates lateral surfaces of the side walls along the height h from the corresponding edge surfaces of the side walls. Furthermore, the coupling elements are arranged in such a way that they can engage with the corresponding coupling elements along the edge surfaces of the rear walls along the height h.

Due to this advantageous arrangement of the coupling elements, it is possible to add to the cuboid storage containers in each spatial direction as desired, with the storage containers engaged with each other sharing at least one cold-insulating wall. Thus, these are the types of extension: in a row, linking the systems “rear wall to rear wall” or a combination of the two possibilities.

Furthermore, it is advantageous that the edge surfaces of the bottoms, of the covers and of the side walls of a storage container, which face the access opening, do not have coupling elements. Moreover, the lateral surfaces along the two lateral edges along the height h, which are adjacent to the access opening, do not have coupling elements. The covers and the bottoms along the two lateral edges along the width b, which are adjacent to the access opening, do not have coupling elements either.

Moreover, unused coupling elements can be closed with a cold-insulating closure. In this regard, by omitting and/or closing unused coupling elements, a further improvement of cold insulation and a reduction of the mounting effort can be achieved.

For the cooling operation, at least one cooling jacket is provided in each of the modular storage containers. This can comprise a liquid or gaseous refrigerant. In this regard, it is advantageous that the temperature can be independently and continuously controlled, in particular for each storage container, from −196° C. to +20° C. Furthermore, it is advantageous if the refrigerant circuits of the cooling jackets of storage containers engaged with each other are connected to each other.

The access openings of the storage containers can be closed by at least one cold-insulating access door which is further configured to be essentially self-closing. This self-closing property can be achieved, for instance, by providing gas pressure springs or mechanical spring elements.

According to an advantageous further embodiment, each storage container has several storage shelves which are open towards the access opening. In this regard, it is advantageous if the storage shelves, towards the access opening, each have a preferably self-closing, separate swing flap for covering the respective storage shelf when the access door is open. Furthermore, it is advantageous if the storage shelves are highly insulated and variable within the interior space, and the storage shelves as well as the swing flaps comprise an in particular highly cold-insulating plastic. By providing storage shelves, which can be opened separately, independently from the access door, it is possible to further reduce the heat input when an item to be cooled is removed and/or deposited.

For the operation of the modular cooling storage system, according to a preferred embodiment, the modular cooling storage system can further comprise a control unit for system control. Furthermore, the cooling storage system can comprise a storage management system control that detects and electronically manages a temperature, a storage location and an expiry date of a stored item for one or more storage containers. With the uniform system control and the storage management system control of the modular cooling storage system, the modular cooling storage system is simple to operate and to manage.

The visualization and control of the system control and/or of the storage management system control for one or more of the storage containers can be performed by a hand-held device, preferably a PDA, or via a screen. In this regard, it is advantageous if the screen is movably guided in a track which extends horizontally and/or vertically over one or more of the storage containers. In a preferred further embodiment of the invention, the system control and/or the storage management system control of the modular cooling storage system are network-compatible.

### BRIEF DESCRIPTION OF THE FIGURES

In the following, the invention will be described in more detail on the basis of an embodiment example.

The drawings show:

FIG. 1 an isometric illustration of a cold-insulating storage container according to the invention;

FIG. 2 a schematic front view of a cold-insulating storage container according to the invention;

FIG. 3 an isometric illustration of a combination of a row of cold-insulating storage containers according to the invention;

FIG. 4 a schematic front view of a combination of a row of cold-insulating storage containers according to the invention;

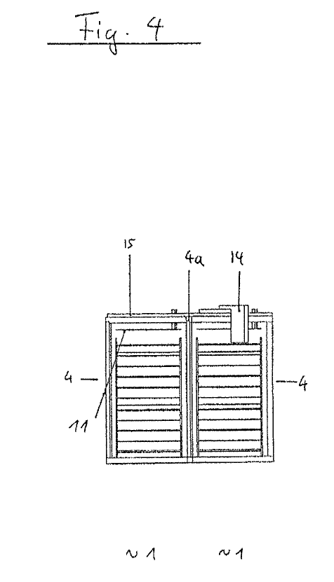

FIG. 5 an isometric illustration of a rear-to-rear combination of cold-insulating storage containers according to the invention;

FIG. 6 a schematic side view of a rear-to-rear combination of cold-insulating storage containers according to the invention;

FIG. 7 an isometric illustration of a combination of rows in a rear-to-rear arrangement of cold-insulating storage containers according to the invention;

### DESCRIPTION OF THE PREFERRED EMBODIMENTS

In the following description of preferred embodiments, the same reference numbers are used for the same or similar elements. A repeated description of certain features in the individual embodiment examples is foregone.

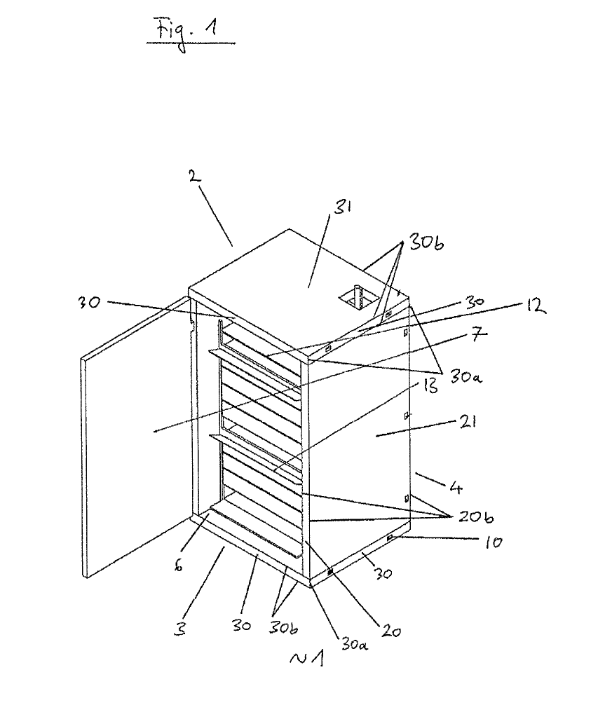

FIG. 1 shows a storage container according to the invention. It has cold-insulating walls 2, 3, 4, 5 which are subdivided, if the storage container is cuboid as shown in FIG. 1, into two side walls 4, a rear wall 5, a bottom 3 and a cover 2. The walls each have two opposite lateral surfaces 21, 31, which are connected to each other in a thickness direction by edge surfaces 20, 30. The storage container further has an access opening 6 closable with an access door 7.

According to the invention, the lateral surfaces 21, 31 and/or edge surfaces 20, 30 of the walls 2, 3, 4, 5 of each storage container 1 have integrated coupling elements 10. The coupling elements 10 are designed in such a way that they can engage with the coupling elements 10 of a directly adjacent wall 2, 3, 4, 5 of a further storage container 1.

For instance, clamp latches can be used as coupling elements. Of two coupling elements engaged with each other, the one is configured as a clamping element and the other as a retaining element. The coupling elements are preferably configured such that, when two coupling elements engage with each other, a tension hook of the clamping element engages with the retaining element. This guarantees high coupling security and, at the same time, enables multiple actuation and makes the system structure flexible and modular.

The rear wall 5 of the storage container 1 has a height h and a width b. The side walls 4 of the storage container 1 have a height h and a length 1. Accordingly, the covers 2 and the bottoms 3 each have the length 1 and the width b, and the access opening has the dimension of a height h and a width b. All of the walls 2, 3, 4, 5 thus have four edge surfaces 20, 30 each and a thickness d.

The arrangement of the coupling elements is described below. The edge surfaces 30 of the bottoms 3 and the covers 2 have at least two and a maximum of 10 coupling elements 10 each, which are arranged in the thickness direction substantially in the middle of the edge surfaces 30. One coupling element is arranged on each edge surface in spatial vicinity of an edge 30a which separates two edge surfaces 30 from each other. The lateral surfaces 31 of the bottom 3 and of the cover 2 have 4*n coupling elements 10 each, with n being a minimum of 1 and a maximum of 10 and preferably 2. In this regard, n coupling elements 10 each are arranged along a lateral edge 30b, which separates a lateral surface 31 from an edge surface 30, at a distance of substantially d/2 from the lateral edge 30b.

The edge surfaces 20 of the side walls 4 have n coupling elements 10 along the length l, which are arranged in such a way that they can engage with the coupling elements 10 on the lateral surfaces 31 along the corresponding lateral edge 30b of the covers 2 and the bottoms 3. The edge surfaces 20 of the rear walls 5 have n coupling elements 10 in a width b, which are arranged in such a way that they can engage with the coupling elements 10 on the lateral surfaces 31 along the corresponding lateral edge 30b of the covers 2 and the bottoms 3.

Furthermore, the edge surfaces 20 of the rear walls have m coupling elements 10 each along the height h, with m being a minimum of 2 and a maximum of 10 and preferably 3. One coupling element each is arranged in spatial vicinity of one of the two edges which separate the edge surfaces along the height h from the adjacent edge surfaces along the width b.

Accordingly, the lateral surfaces 21 of the side walls 4 have m coupling elements each along the height h, which are each arranged at a distance of substantially d/2 from the lateral edge 20b, which separates the lateral surfaces 21 of the side walls 4 along the height h from the corresponding edge surfaces 20 of the side walls 4. The coupling elements 10 on the lateral surfaces 21 of the side walls 4 are further arranged in such a way that they can engage with the corresponding coupling elements 10 along the edge surfaces 20 of the rear walls 5 along the height h.

The edge surfaces 20, 30 of the bottoms 3, of the covers 2 and of the side walls 4 of the storage container 1, which face the access opening 6, however, do not have coupling elements 10. The lateral surfaces 21 of the side walls 4 along the two lateral edges 20b along the height h, which are adjacent to the access opening 6, do not have coupling elements 10 either. The covers 2 and the bottoms 3 along the two lateral edges 30b, which are adjacent to the access opening 6 along the width b, do not have coupling elements 10 either.

According to a preferred embodiment, the lateral surfaces 21, 31 and the edge surfaces can be formed of thin sheet steel, the thickness of which lies in the range of one millimeter. Polyurethane foam can be incorporated between the steel sheets. Depending on the type of insulation, the thickness of this polyurethane foam layer can be between 80 mm and 200 mm. To further improve the insulating properties, super vacuum insulation integrated in glass-fiber reinforced plastic can be applied to those lateral surfaces 21, 31 which form the interior surfaces of one or more storage containers 1. This super vacuum insulation can consist of vacuum packs which are laminated in several layers and arranged between cast vacuum elements made of a fiber-plastic composite (glass-fiber reinforced plastic). A vacuum pack can be, for instance, an aluminum film filled with silicic acid and vacuum-drawn.

Furthermore, at least one cooling jacket 11 is provided in the storage container, which comprises a liquid or gaseous refrigerant. The temperature in the storage container can be continuously controlled from −196° C. to +20° C.

The access door 7, which closes the access opening 6 of the storage container, can be configured to be self-closing. The self-closing property can be ensured by a gas pressure spring or mechanical spring.

Furthermore, the storage container 1 has several storage shelves 12 which are open towards the access opening 6. The storage shelves are configured in such a way that they have a separate swing flap 13 towards the access opening 6 for covering the storage shelves 12 even when the access door 7 is open. Similar to the access door 7, the swing flaps 13 can be provided with a self-closing mechanism. The individual storage shelves 12 are highly insulating and variable within the interior space, and the storage shelves 12 as well as the swing flaps 13 consist of a highly cold-insulating plastic.

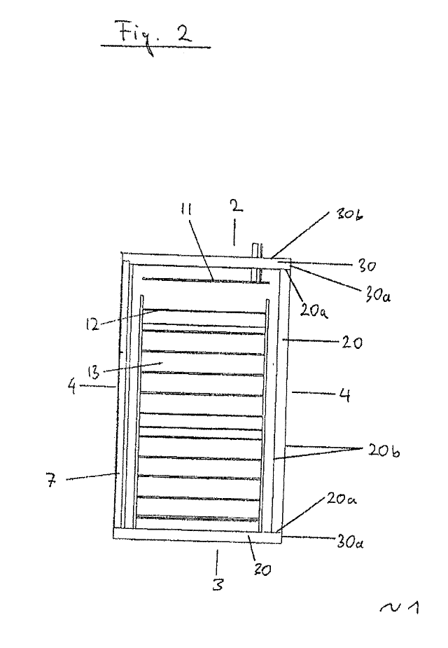

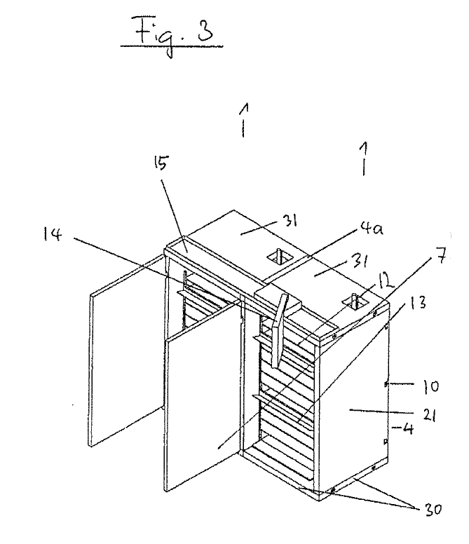

FIG. 3 describes a possibility for coupling two storage containers described in FIGS. 1 and 2. In this regard, two storage containers 1 are arranged next to each other in a row and, laterally, they are completely flush (i.e. exactly or completely covering each other). Furthermore, the two storage containers 1 are engaged with each other via the coupling elements 10 and have a common side wall 4a. The covers 2 and the bottoms 3 of the two storage containers 1 extend uniformly over both storage containers 1. Otherwise, the two storage containers 1 correspond to the storage container 1 illustrated in FIG. 1.

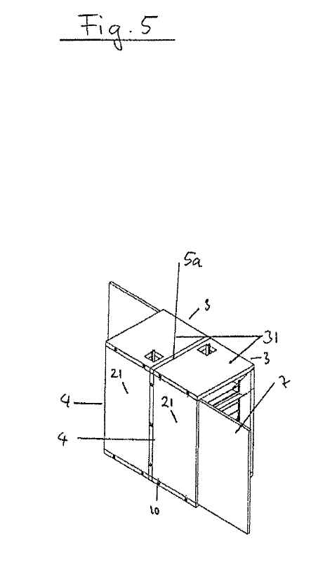

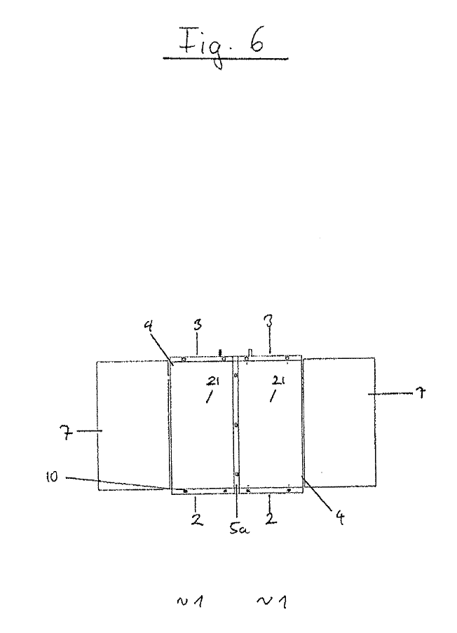

FIGS. 5 and 6 show a possibility for coupling two storage containers 1 directly adjacent to each other rear-to-rear. The two storage containers 1 are engaged with each other via the coupling elements 10 and have a common rear wall 5a. Otherwise, the two storage containers correspond to the storage container 1 illustrated in FIG. 1.

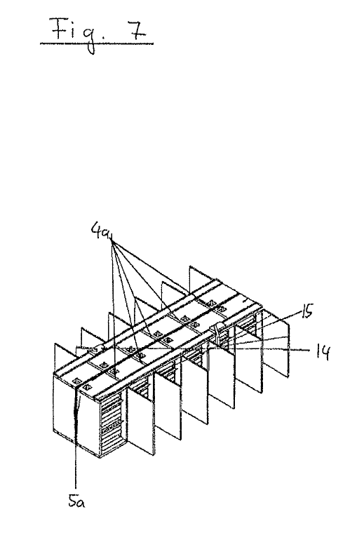

Finally, FIG. 7 shows a combination of twelve storage containers 1, 6 of which are respectively arranged in a row, rear-to-rear and engaged with each other. Thus, the storage containers 1 each have one common rear wall 5a and five common side walls 4a.

Furthermore, it is possible to stack individual storage containers 1 on top of each other, wherein storage containers 1, which are arranged on top of each other to be completely flush (i.e. exactly or completely covering each other) and are engaged with each other, have a common wall that serves as the cover of the lower storage containers and as the bottom of the upper storage containers 1.

The storage containers connected with each other in this manner in a row and/or rear-to-rear and/or on top of each other have cooling jackets 11, the refrigerant circuits of which can be connected with each other. The temperature can be independently and continuously controlled for each of the coupled storage containers 1.

The modular cooling storage system, which comprises several individual storage containers 1, further comprises a uniform system control that enables control of the cooling storage system. Furthermore, the modular cooling storage system has a storage management system control that enables detection and monitoring of the identification data of individual stored items. These identification data include, inter alia, the storage location, the expiry date, the temperature course and the composition of the individual stored items.

The visualization and control of the system control and/or of the storage management system control is performed either by a hand-held device, preferably a PDA, or a screen 14. The screen 14 is movably guided in a track 15 which extends horizontally and/or vertically over one or more of the storage containers 1. The track 15 is preferably mounted on the lateral surfaces 31 of the covers 2. Both the system control and the storage management system control can be network-compatible.

1. A modular cooling storage system comprising:
one or more storage containers, each having cold-insulating walls, comprising at least one side wall, a bottom and a cover; wherein
the cold-insulating walls have two opposite lateral surfaces, which are connected to each other in a thickness direction by edge surfaces; and wherein
each storage container has at least one closable access opening; characterized in that
the lateral surfaces and/or edge surfaces, of at least one of the walls of each storage container comprise integrated coupling elements, wherein
the coupling elements of one storage container engage with the coupling elements of a directly adjacent wall of a further storage container, wherein
storage containers engaged with each other along a section of the walls of the storage containers have a common wall where the adjacent containers engage.

2. The modular cooling storage system according to claim 1, characterized in that each storage container is substantially cuboid in geometry.

3. The modular cooling storage system according to claim 2, wherein storage containers, which are arranged directly adjacent to each other to be completely flush have a common side wall.

4. The modular cooling storage system according to claim 3, wherein
one side wall of each of the storage containers, which is opposite to the respective access opening, is formed as a rear wall of the respective storage container and has a height, h, and a width, wherein
the side wall of each of the storage containers, in which the access opening is provided, has the height, h, and the width, b, wherein
the other side walls have the height, h, and a length, l, wherein
the covers and the bottoms each have a length, l, and a width, b, and wherein
the covers, the bottoms, the rear walls and the side walls have four edge surfaces, each with a thickness, d.

5. The modular cooling storage system of claim 1, wherein the covers and/or the bottoms of directly adjacent storage containers extend uniformly over all directly adjacent storage containers.

6. The modular cooling storage system according to claim 1, wherein storage containers, which are arranged on top of each other and are engaged with each other, have a common layer that serves as the cover of the lower storage containers and as the bottom of the upper storage containers.

7. The modular cooling storage system according to claim 4, wherein
the edge surfaces of the bottoms and the covers have at least two and a maximum of 10 coupling elements each of which are arranged in the thickness direction substantially in the middle of one of the edge surfaces, with one coupling element being arranged on each edge surface in a spatial vicinity of an edge which separates two edge surfaces from each other, and wherein
the lateral surfaces of the bottom and of the cover have 4*n coupling elements each, with n being a minimum of 1 and a maximum of 10, and with n coupling elements, each arranged along a lateral edge, which separates a lateral surface from an edge surface at a distance of substantially d/2 from the lateral edge.

8. The modular cooling storage system according to claim 7, wherein
the edge surfaces of the side walls have n coupling elements along the length, l, which are arranged in such a way that they can engage with the coupling elements on the lateral surfaces along the corresponding lateral edge of the covers and the bottoms, wherein
the edge surfaces of the rear walls have n coupling elements along the width, b, which are arranged in such a way that they engage with the coupling elements on the lateral surfaces along the corresponding lateral edge of the covers and the bottoms, wherein
the edge surfaces of the rear walls have m coupling elements each along the height, h, with m being a minimum of two and a maximum of 10, and with one coupling element each being arranged in spatial vicinity of one of the two edges which separate the edge surfaces along the height, h, from the adjacent edge surfaces along the width b, and wherein
the lateral surfaces of the side walls have m coupling elements each along the height, h, which are each arranged at a distance of substantially d/2 from the lateral edge, which separates the lateral surfaces of the side walls along the height, h, from the corresponding edge surfaces of the side walls, and which are further arranged in such a way that they engage with the corresponding coupling elements along the edge surfaces of the rear walls along the height, h.

9. The modular cooling storage system according to claim 7, wherein
the edge surfaces of the bottoms of the covers and of the side walls of a storage container, which face the access opening, do not have coupling elements, wherein
the lateral surfaces along two lateral edges along the height, h, which are adjacent to the access opening, do not have coupling elements, and wherein
the covers and the bottoms along the two lateral edges along the width, b, which are adjacent to the access opening, do not have coupling elements.

10. The modular cooling storage system according to claim 1, wherein unused coupling elements are closed with a cold-insulating closure.

11. The modular cooling storage system according to claim 1, wherein at least one cooling jacket is provided in each of the storage containers.

12. (canceled)

13. The modular cooling storage system according to claim 1, wherein a temperature within the system can be independently and continuously controlled for each storage container (1) from −196° C. to +20° C.

14. (canceled)

15. The modular cooling storage system according to claim 1, wherein the access openings of the storage containers are closed by at least one cold-insulating access door.

16. The modular cooling storage system according to claim 15, wherein the access doors are configured to be self-closing.

17. The modular cooling storage system according to claim 1, wherein each storage container further comprises several storage shelves which are open towards the access opening.

18. The modular cooling storage system according to claim 17, wherein the storage shelves, towards the access opening each comprise a self-closing, separate swing flap for covering the respective storage shelf when the access doors are open.

19. The modular cooling storage system according to claim 18, wherein the storage shelves are insulating within the interior space, and the storage shelves, as well as the swing flaps, comprise a cold-insulating plastic.

20. The modular cooling storage system according to claim 18, wherein the access doors and/or the swing flaps are provided with a motor-operated, automatic opening and closing device.

21. (canceled)

22. The modular cooling storage system according to claim 1, wherein the cooling storage system further comprises a storage management system control that detects and manages a temperature, a storage location and an expiry date of a stored item for one or more of the storage containers.

23. The modular cooling storage system according to claim 22, wherein a visualization and control of the system control and/or of the storage management system control for one or more of the storage containers is performed by a hand-held device, or a screen.

24. (canceled)

25. (canceled)
